(19) United States
(12) Patent Application Publication
(10) Pub. No.: US 2016/0062987 A1
(43) Pub. Date: Mar. 3, 2016

(54) LANGUAGE INDEPENDENT CUSTOMER COMMUNICATIONS

(71) Applicant: NCR Corporation, Duluth, GA (US)

(72) Inventors: Raja Shekhar Yapamanu, Hyderabad (IN); Uma Varakumari Gadasala, Andhra Pradesh (IN); Marreddy Thumma, Hyderabad (IN); Mandapati Venkata Pradeep, Hyderabad (IN); Deepthi Gadde, Anantapur (IN); Ian Maxwell Joy, Fife (GB); Gordon Patton, Fife (GB)

(21) Appl. No.: 14/468,517

(22) Filed: Aug. 26, 2014

(51) Int. Cl. G06F 17/28; G06Q 20/10; G06Q 30/02; G06Q 20/18

(52) U.S. Cl. CPC G06F 17/28; G06Q 20/18; G06Q 20/1085; G06Q 30/0281

(57) ABSTRACT

A first user establishes a communication session with a second user. During the communication session the first user communicates and receives communication from the second user in a first human language while the second user communicates and receives communication from the first user in a second communication language. The first and second human communication languages are different from one another. In an embodiment, at least one human communication language is sign language. In an embodiment, at least one human communication language is communicated via animation.

### BACKGROUND

Increasingly, the world is becoming globalized. It is not uncommon to be anywhere in the world and encounter individuals that do not speak the native language or dialect of the region. Moreover, even though English is widely spoken many non-native English speakers are often more comfortable speaking in their native tongues. Furthermore, in some areas of the world English is only spoken by the well-to-do or well educated. Yet, businesses need to server not only the well-to-do and well educated but also the common people and uneducated.

A typical response to this situation by businesses and governments is to provide automated phone services that can interact in various spoken languages, but even English speaking people loath to interact with such services because of the error rate, long delays, and multiple voice menus to toggle through before a live person can be spoken with.

Another solution in the industry is to have a customer select a desired language and then have the customer's call routed to someone that can assist the customer in the customer's native tongue. But, this is an expensive solution of the industry and often entails hiring or outsourcing workers that are expensive. Still further, many times such a customer is routed to an employee or contractor that is remotely located where the time of day may be such that the worker is half awake or not even fully versed in all the business's policies and procedures, which still further frustrates the customer.

In yet another case, a customer may not be able to hear (deaf), such that no matter the spoken language the customer is unable to communicate with a representative of a business using conventional voice communications.

In still another situation, a customer or even an employee of a business may not wish to be seen during available video communications because of religious reasons or other reasons, such as when the employee is remotely located and working from home and not in a presentable business form for the business to visually interact with a customer of the business.

### SUMMARY

In various embodiments, methods and a Self-Service Terminal (SST) for language independent customer communications are presented.

According to an embodiment, a method for language independent customer communications is provided. Specifically, a first human communication language is identified for a first user of a first device and a second human communication language is identified for a second user of a second device. Next, the first human communication language and the second human communication language are dynamically bridged between the first user and the second user by translating between the first and second human communication languages during the communication session.

According to another embodiment there is provided a method, comprising: identifying a first human communication language for a first user of a first device and a second human communication language for a second user of a second device; and dynamically bridging a communication session between the first user and the second user by translating between the first and second human communication languages during the communication session.

Identifying optionally further includes recognizing the first and second human communication languages as different spoken languages.

Identifying optionally further includes recognizing at least one of the human communication languages as a universal sign language.

Dynamically bridging optionally further includes providing the communication session as an audio feed between the first and second users.

Dynamically bridging optionally further includes providing the communication session as video and audio feed between the first and second users.

Dynamically bridging optionally further includes providing at least one side of the communication session as an animation.

Providing optionally further includes animating an avatar to perform sign language as the human communication language associated with the at least one side of the communication.

Dynamically bridging optionally further includes providing at least one side of the communication session in written text for that side's human communication language.

Dynamically bridging optionally further includes providing one side of the communication session in one communication mode and a remaining side of the communication session in a different communication mode.

Dynamically bridging optionally further includes encrypting the communication session during transmission over a network between the first user and the second user.

According to yet another embodiment there is provided a method, comprising: requesting, from a Self-Service Terminal (SST), a cross-language human communication session with a remote agent; establishing the cross-human language communication session with the remote agent; and dynamically translating between a first human language of a customer operating the SST and a second human language of the remote agent.

Requesting optionally further includes making a request based on an offer for assistance sent from the remote agent to a screen of a display associated with the SST, the request activated from the screen by the customer.

Requesting optionally further includes selecting, by the customer, the first human language from a menu option presented within a screen of a display associated with the SST.

Selecting optionally further includes selecting a mode for the communication session, by the customer, from options presented within the screen.

Selecting the mode optionally further includes presenting the options as one of: an animation with an avatar mode, the animation with the avatar animated to perform sign language mode, a modified video of a person performing sign language mode, an audio only mode, a video and audio mode, a video and text mode, and a written text only mode.

Dynamically translating optionally further includes providing the customer operating the SST with a first communication mode for the communication session that is different than a second communication mode for the communication session received by the remote agent for the communication session.

According to a further embodiment there is provided a Self-Service Terminal (SST), comprising: a language bridge configured and adapted to: i) execute on the SST, ii) establish a communication session with a remote agent, and iii) dynamically bridge between a first human language used by a customer operating the SST and a second human language used by the remote agent during the communication session.

The language bridge is optionally further configured and adapted to v) provide the communication session in a communication mode selected by the customer.

The communication mode is optionally animated with an avatar representing the customer to the remote agent during the communication session.

The SST is optionally an Automated Teller Machine (ATM) and the remote agent is optionally a teller.

### BRIEF DESCRIPTION OF THE DRAWINGS

FIGS. 1A-1C are diagrams illustrating language independent customer communications, according to an example embodiment.

FIG. 2 is a diagram for practicing language independent customer communications, according to an example embodiment.

FIG. 3 is a diagram of a method for language independent communications, according to an example embodiment.

FIG. 4 is a diagram of another method for language independent communications, according to an example embodiment.

FIG. 5 is a diagram of a Self-Service Terminal (SST), according to an example embodiment.

### DETAILED DESCRIPTION

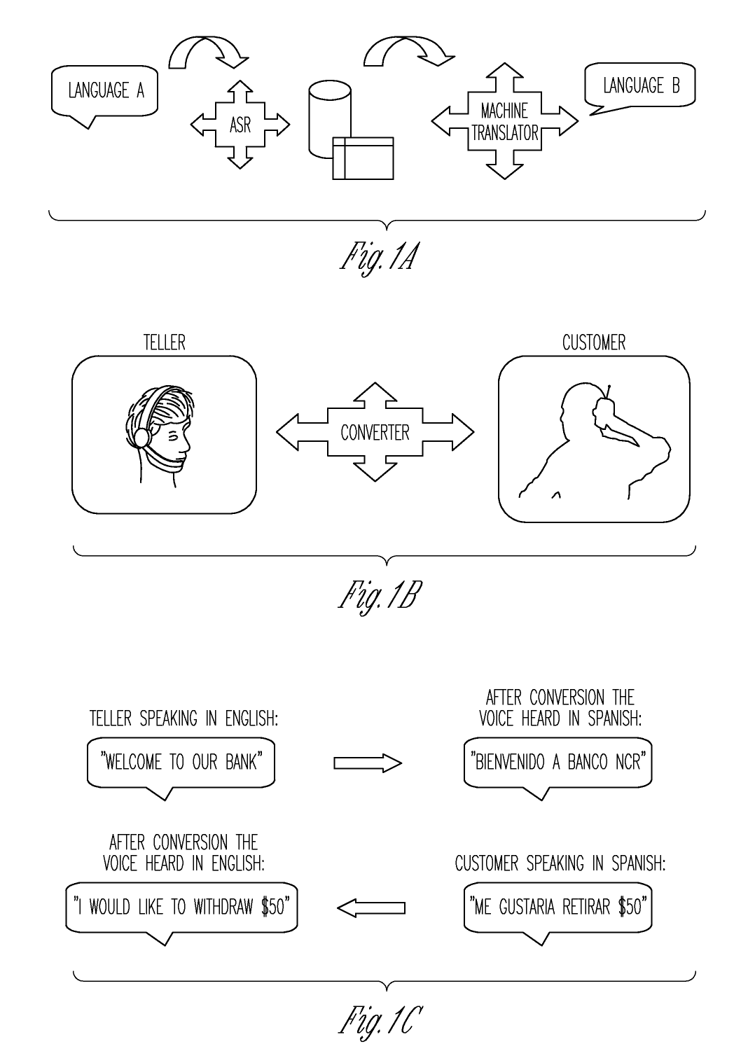

FIGS. 1A-1C are diagrams illustrating language independent customer communications, according to an example embodiment.

FIG. 1A illustrates an automated mechanism for translating audio communications between a customer and an assistant/teller (any two individuals). The first speaker of Language A speaks into a microphone and an Automatic Speech Recognition (ASR) module recognizes the speech (in the Language A's audio format). The ASR compares the speech input data with a phonological module (for speech data can be voluminous in size) based on multiple speakers from Language A. The input speech data is then converted into a string of words, using a dictionary and grammar for the Language A, based on a massive corpus of text associated with Language A.

Next, the machine translation module translates the string, and an entire context for the input speech is generated into an appropriate translation for Language B (a first speaker provided the speech in Language A, which is translated to the string and input speech generated for a second speaker to hear in Language B). The translated speech data is then sent to a speech synthesis module, which estimates pronunciation and intonation matching the translated string of words for Language B based on a speech corpus of data for the Language B. Waveforms matching the translated string of words are selected from the Language B corpus of data and speech synthesis connects and outputs the translated string of words in audio format for Language B.

FIGS. 1B-1C illustrate a Teller speaking in native English with a customer of an enterprise speaking in native Spanish that passes through the converter process, which was detailed in the FIG. 1A. The conversation audio communication between the teller and the customer is presented as an example in the FIG. 1C (the audio transcribed in written form, since it is apparent this conversation would be purely audio based) with the arrows indicating the direction of the speech being sent from one participant in the direction of the receiving participant.

It is noted that FIGS. 1A-1C illustrate one audio-based approach to the language independent customer communications presented herein. There are embodiments that will be discussed herein related to visual communication and audio with visual communications, which are useful for animated based communication translating speech to sign language (and vice-versa) and which are useful to preserve visual anonymity during video communication between two-parties.

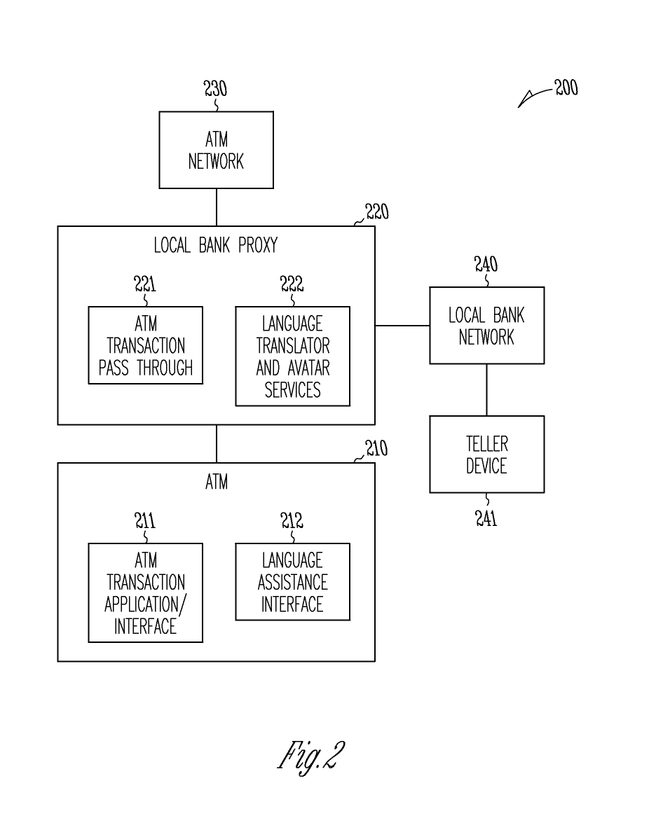

FIG. 2 is a diagram 200 for practicing language independent customer communications, according to an example embodiment. It is to be noted that the ATM 210 is shown schematically in greatly simplified form, with only those components relevant to understanding of this embodiment being illustrated. The same situation may be true for the local bank proxy 220, and teller device 241.

Furthermore, the various components (that are identified in the FIG. 2) are illustrated and the arrangement of the components is presented for purposes of illustration only. It is to be noted that other arrangements with more or less components are possible without departing from the teachings of language independent customer communications, presented herein and below.

Furthermore, methods and SST presented herein and below for language independent communications can be implemented in whole or in part in one, all, or some combination of the components shown with the diagram 200. The methods are programmed as executable instructions in memory and/or non-transitory computer-readable storage media and executed on one or more processors associated with the components.

Specifically, the diagram 200 permits language independent communications to occur in real time between a customer operating the ATM 220 with a teller operating the teller device 241 through a local bank proxy 220 of a local bank network 240. The details of this approach in view of the components, within the diagram 200, are now presented with reference to an embodiment of the FIG. 2 within the context of an ATM 210.

However, before discussion of the diagram 200 is presented, it is to be noted that the methods and SST presented herein are not limited to ATM solutions; that is, any SST terminal (kiosk, vending machine, check-in and/or check-out terminal, such as those used in retail, hotel, car rental, healthcare, or financial industries, etc.) can benefit from the language independent customer discussions discussed herein and some which may not even utilize an SST but may be conducted via a device capable of audio and/or video communications.

The diagram 200 includes an ATM 210, a local bank proxy (intermediary server) 220, an ATM network 230, a local bank network 240, and a teller device 241. The ATM 210 includes an ATM transaction/application interface 211 and a language assistance interface 212. The local bank proxy 220 includes an ATM transaction pass through 221 and language translator and avatar services 222.

A customer approaches the ATM 210 for a transaction. The transaction can initially be directed to an ATM transaction or can be directed to interaction with a teller for assistance. For an ATM transaction, the customer selects a language from the prompts that matches a spoken language of the customer and provides a bank card and then enters the requisite information to select a particular transaction from the menu prompts of the ATM Transaction Application/Interface 211. In some cases, the language the customer desires can be identified from the bank card, such that no prompts are necessary at all. Some of the information supplied by the customer maybe encrypted, such as any Personal Identification Number (PIN). The initial transaction details are directed from the ATM to the ATM network 230 for processing but before reaching the ATM network 230, the transaction details are intercepted by the local bank proxy 220 by the ATM Transaction Pass through 221, which acts as a transparent pass through between the ATM 210 and the ATM network 230 but also provides a connection between the ATM 210 and the local bank network 240 to which the teller device 241 is connected.

At any time a customer is identified as needing assistance or requests assistance, the teller device 241 has access to the transaction details through the local bank proxy 220 interfaced to the local bank network 240. Again, the customer can initiate a request for assistance through the language assistance interface 212, which is received by the teller at the teller device 241 through the local bank network 240 interfaced to the local bank proxy 220.

The language assistance interface 212 also presents a variety of menu options that permit a customer to determine how they would like to receive assistance from a teller this can include, but is not limited to, selections for: communication via a specific spoken human language, communication via sign language for hearing impaired customers, communication via a video feed to include audio and video, and a selection to anonymize the appearance of the customer by performing a video session with a teller in which the customer appears as an animated avatar to the teller during the video session. Similarly, the teller can during a video session anonymize his/her appearance as an animated avatar presented in a video session to the customer. In fact both the teller and the customer can both appear as avatars to one another.

Communication during a customer assistance scenario occurs through the language translator and avatar services 222 of the local bank proxy 220. This can include the converter discussed above in the FIG. 1A. Additionally, when an avatar is used actions and facial features of the customer and/or teller can be captured and mimicked in the customer's avatar and/or teller's avatar through the language translator and avatar services 222. Moreover, when the customer elects to have sign language and the teller does not speak sign language, the teller's spoken human language is translated into the universal sign language format and communicated via a teller avatar through the language translator and avatar services 222.

The sign language avatar approach (through the language translator and avatar services 222 bridges a communication channel between the teller and the customer who may have speaking and/or hearing impediments and who understands sign language. A sign language is a language which uses manual communication and body language to convey meaning, as opposed to acoustically conveyed sound patterns. This can involve simultaneously combining hand shapes, orientation and movement of the hands, arms or body, and facial expressions to fluidly express a speaker's thoughts. In this scenario, the teller's preferred form of communication can be translated into body language (sign language), which is understood by the customer and customer responses in sign language translated back to teller (in the teller's preferred form of communication) to progress with customer communications.

It is noted that with sign language the teller can type instructions or selected pre-packed text instructions from the teller device 241 to make the tasks of the language translator and avatar services 222 easier. Moreover, when the teller uses speech, the converter of the language translator and avatar services 222 can take the text strings for the spoken speech and rather than pass those text strings to a target language speech translator and speech synthesizer, the text strings are passed to the sign language converter within the language translator and avatar services 222. In a reverse scenario, the captured sign language communication of the customer in front of the ATM 210 through the language assistance interface and using a camera of the ATM 210 to capture the customer sign language can be passed as a video stream to the language translator and avatar services 222 where the video stream is parsed for hand signals and gestures and converted to text which can be fed directly as text to the teller at the teller device 241 and/or run through the language converter to be fed as an audio stream to the teller in speech at the teller device 241.

The avatar communication can be a two way avatar video session or one way only avatar session, meaning one party sees an avatar while the other party sees a real person on the video feed. Moreover, the sign language communication can use an avatar or can use a modified video of a real person that performs all sign language communications such that the video is modified to achieve the needed communication from the teller. It is also noted that the teller may be hearing impaired and may also benefit from sign language communication, so the sign language can be a two-way sign language communication or a one way communication (the customer or the teller requiring the sign language communication).

Anonymity with an avatar communication may be desired in a variety of scenarios, such as but not limited to, customer preference, customer culture, customer religion, customer embarrassment of appearance, and others.

In an embodiment, the teller device 241 is a tablet.

In an embodiment, the teller device 241 is a wearable processing device.

In an embodiment, the teller device 241 is a terminal device.

In an embodiment, the teller device 241 can communicate over the local bank network 240 using a wireless connection.

In an embodiment, the teller device 241 can communicate over the local bank network 240 using a wired connection.

In an embodiment, the teller device 241 can communicate over the local bank network 240 using both a wired and wireless connection.

In an embodiment, the communication between the customer and the teller is strictly audio without video (such as discussed above with reference to the FIGS. 1A-1C.

In an embodiment, the communication between the customer and the teller is audio for one party and animated or non-animated for the second party. Such as when the teller is hearing impaired but the customer is not, the customer can receive translated audio converted from the teller's sign language gesters and teller receives animated or modified real video for translated audio communicates sent from the customer. This may also be useful for a teller with an ear piece and not capable or based on location or task at hand at looking at the screens of the teller device 241, such that the customer sees video or animation and the teller hears only audio and communicates via a microphone, perhaps associated with the headset or in the vicinity of the headset such that it can receive audio speech from the teller.

One now appreciates how real-time language independent customer communications can be provided for customer assistance while at an ATM 210 of a bank branch.

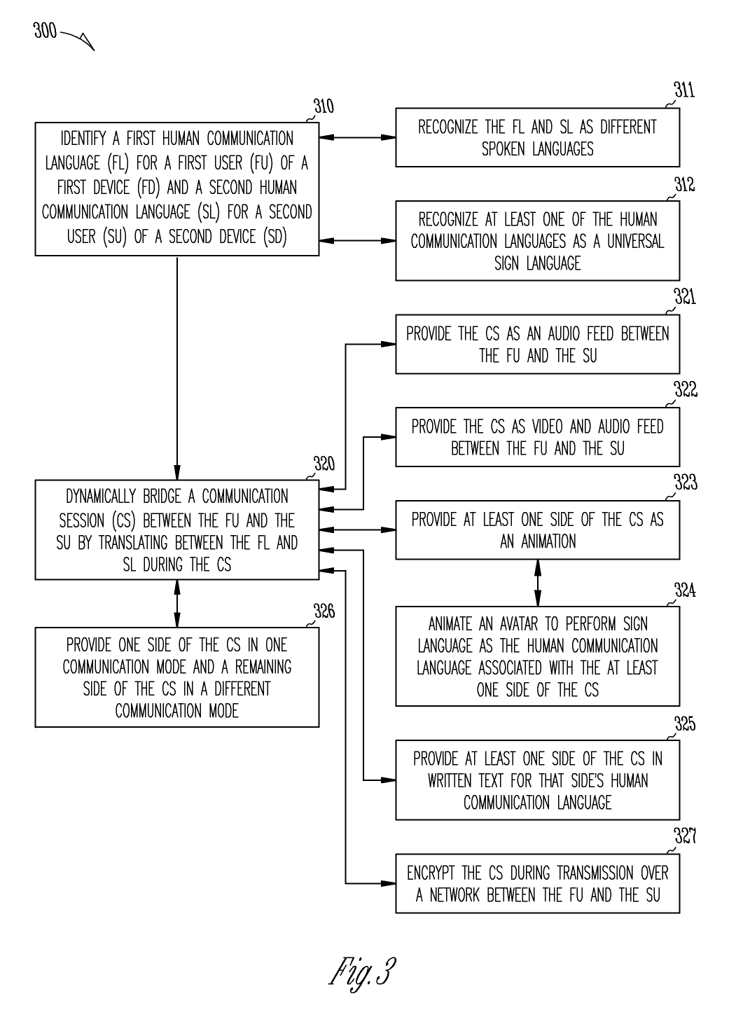

Some embodiments of the FIGS. 1A-1C and the FIG. 2 and other embodiments of the language independent customer communications are now discussed with the descriptions of the FIGS. 3-5.

FIG. 3 is a diagram of a method 300 for language independent communications, according to an example embodiment. The software module(s) that implements the method 300 is referred to as a “language bridge.” The language bridge is implemented as executable instructions programmed and residing within memory and/or a non-transitory computer-readable (processor-readable) storage medium and executed by one or more processors of a device. The processor(s) of the device that executes the language bridge are specifically configured and programmed to process the language bridge. The language bridge has access to a network during its processing. The network can be wired, wireless, or a combination of wired and wireless.

In an embodiment, the device that executes the language bridge is the local bank proxy 222 of the FIG. 2.

In an embodiment, the device that executes the language bridge is the teller device 241 of the FIG. 2.

In an embodiment, the device that executes the language bridge is the ATM 210 of the FIG. 2.

In an embodiment, the device that executes the language bridge is an SST.

In an embodiment, the device that executes the language bridge is a desktop computer.

In an embodiment, the device that executes the language bridge is a mobile device, such as but not limited to, a laptop computer, a tablet, a phone, and/or a wearable processing device (such as GOOGLE™ GLASS™, and others).

In an embodiment, the device that executes the language bridge is a server.

In an embodiment, the device that executes the language bridge is a device associated with a cloud processing environment.

In an embodiment, different features of the language bridge processes on different cooperating devices networked together.

In an embodiment, the language bridge is implemented as Software as a Service (SaaS) accessible to other devices from a network connection.

The processing of the language bridge assumes that two parties are in communication with one another, with each using a different language (spoken or signed). The communication can also be video-based, audio-based, animated, or combinations of video, animation, and audio.

At 310, the language bridge identifies a first human communication language for a first user of a first device and a second human communication language for a second user of a second device.

The human communication languages are written, spoken, or signed languages that humans use to communicate. The human communication languages are not computer languages for programming computers.

In an embodiment, at 311, the language bridge recognizes the first human communication language and the second communication language as spoken languages associated with speech of two different languages.

In an embodiment, at 312, the language bridge recognizes at least one of the human communication languages as a universal human sign language.

At 320, the language bridge dynamically and in real time bridges a communication session between the first user and the second user by translating between the first human communication language and the second human communication language during the communication session. So, the first user communicates to and receives communications from the second user in the first human communication language during the communication session. Similarly, the second user communicates to and receives communications from the first user in the second human communication language during the communication session.

According to an embodiment, at 321, the language bridge provides the communication session as an audio feed between the first user and the second user.

In an embodiment, at 322, the language bridge provides the communication session as a video and audio feed between the first user and the second user.

In an embodiment, at 323, the language bridge provides at least one side of the communication session as an animation.

In an embodiment of 323 and at 324, the language bridge animates an avatar to perform sign language as the human communication language associated with the at least one side of the communication session having the animation.

In an embodiment, at 325, the language bridge provides at least one side of the communication session in written text for that side's human communication language.

In an embodiment, the language bridge provides a combination of video, text, and speech for at least one side of the communication session.

In an embodiment, at 326, the language bridge provides one side of the communication session on one communication mode and a remaining side of the communication session in a different communication mode. The communication modes can include one or more of: text, audio, video, animation, or combinations of these things.

In an embodiment, at 327, the language bridge encrypts the communication session during transmission over a network between the first user and the second user for added security. In an embodiment, the encryption occurs using a secure network protocol that provides the encryption. In an embodiment, the encryption and decrypting occurs at the first and second device and the encrypted communications sent over an insecure network, such as the Internet.

It is to be noted that although communications are discussed in terms of two individuals herein that the teachings are not so limited because groups of users in a video chat can utilize the same dynamic and real time language translation. For example, a SKYPE™ group chat could be used with each user receive a different language from the other users and the group includes more than 2 individuals.

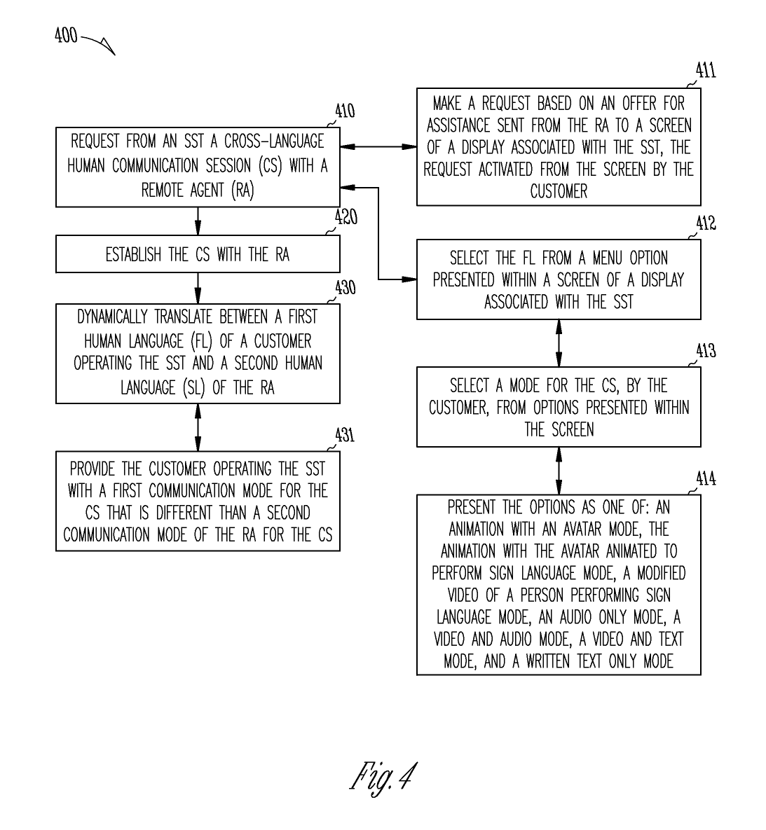

FIG. 4 is a diagram of another method 400 for language independent communications, according to an example embodiment. The software module(s) that implements the method 300 is referred to as a “SST language translator.” The SST language translator is implemented as executable instructions programmed and residing within memory and/or a non-transitory computer-readable (processor-readable) storage medium and executed by one or more processors of an SST. The processors that execute the SST language translator are specifically configured and programmed to process the SST language translator. The SST language translator has access to one or more networks during its processing. Each network can be wired, wireless, or a combination of wired and wireless.

In an embodiment, the SST is the ATM 210 of the FIG. 2.

In an embodiment, the SST is a kiosk.

In an embodiment, the SST is self-service grocery checkout station.

In an embodiment, the SST language translator is the language bridge of the FIG. 3.

At 410, the SST language translator requests from an SST a cross-language communication session with a remote agent. By cross-language it is meant one side of the communication session uses a different human communication then the other side of the communication session.

According to an embodiment, at 411, the SST language translator makes a request based on an offer for assistance sent from the remote agent to a screen of a display associated with the SST. The customer activates the request from the screen for engaging with the remote agent.

In an embodiment, at 412, the SST language translator permits the customer to make a selection from a menu option presented within a screen of a display associated with the SST for purposes of the customer selecting a first human language for use by the customer.

In an embodiment of 412 and at 413, the SST language translator permits the customer to select a mode for the communication session from other options presented within the screen.

In an embodiment of 413 and at 414, the SST language translator presents the options as one or more of: an animation with an avatar mode, the animation with the avatar animated to perform sign language as the first human language, a modified video of a person performing sign language mode, an audio only mode, a video and audio mode, a video and text mode, and a written text only mode.

At 420, the SST language translator establishes the communication session with the remote agent.

At 430, the SST language translator dynamically translates between a first human language of a customer operating the SST and a second human language of the remote agent.

In an embodiment, at 431, the SST language translator provides the customer operating the SST with a first communication mode for the communication session that is different from a second communication mode used by the remote agent for the communication session.

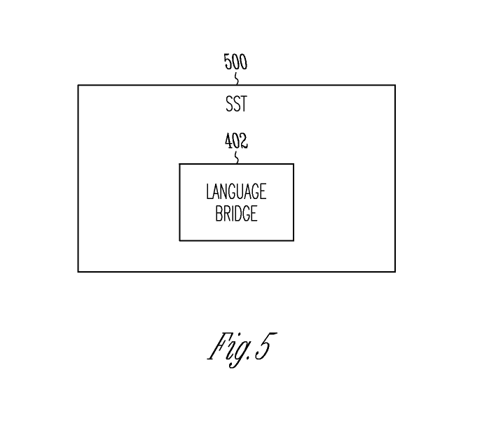

FIG. 5 is a diagram of an SST 500, according to an example embodiment. The components of the SST 500 are programmed and reside within memory and/or a non-transitory computer-readable medium and execute on one or more processors of the SST 500. The SST 500 communicates and has access one or more networks, which can be wired, wireless, or a combination of wired and wireless.

In an embodiment, the SST 500 is the ATM 210 of the FIG. 2.

In an embodiment, the SST 500 is a kiosk.

In an embodiment, the SST 500 is a self-service grocery checkout station.

The SST 500 includes a language bridge 501.

The language bridge 501 is configured and adapted to: execute on the SST 500, establish a communication session with a remote agent, and dynamically bridge (translate or convert) between a first human language used by a customer operating the SST 500 and a second human language used by the remote agent during the communication session.

In an embodiment, the language bridge 501 is the language bridge of the FIG. 3.

In an embodiment, the language bridge 501 is the SST language translator of the FIG. 4.

In an embodiment, the remote agent is a teller operating the teller device 241 of the FIG. 2.

According to an embodiment, the language bridge 501 is further configured and adapted to provide the communication session in a communication mode selected by the customer. In an embodiment, the communication mode is animated with an avatar representing the customer to the remote agent during the communication session.

One now appreciates how improved customer communication can occur between a customer and a remote agent using a preferred human communication language of the customer and a different preferred human communication language of the remote agent. The languages are dynamically translated between one another during the communication session between the customer and the remote agent. Moreover, different communication modes can be used during the communication session. In some embodiments, the communication mode includes animation with one or more avatars. In an embodiment, at least one language is sign language.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
identifying a first human communication language for a first user of a first device and a second human communication language for a second user of a second device; and
dynamically bridging a communication session between the first user and the second user by translating between the first and second human communication languages during the communication session.

2. The method of claim 1, wherein identifying further includes recognizing the first and second human communication languages as different spoken languages.

3. The method of claim 1, wherein identifying further includes recognizing at least one of the human communication languages as a universal sign language.

4. The method of claim 1, wherein dynamically bridging further includes providing the communication session as an audio feed between the first and second users.

5. The method of claim 1, wherein dynamically bridging further includes providing the communication session as video and audio feed between the first and second users.

6. The method of claim 1, wherein dynamically bridging further includes providing at least one side of the communication session as an animation.

7. The method of claim 6, wherein providing further includes animating an avatar to perform sign language as the human communication language associated with the at least one side of the communication.

8. The method of claim 1, wherein dynamically bridging further includes providing at least one side of the communication session in written text for that side's human communication language.

9. The method of claim 1, wherein dynamically bridging further includes providing one side of the communication session in one communication mode and a remaining side of the communication session in a different communication mode.

10. The method of claim 1, wherein dynamically bridging further includes encrypting the communication session during transmission over a network between the first user and the second user.

11. A method, comprising:
requesting, from a Self-Service Terminal (SST), a cross-language human communication session with a remote agent;
establishing the cross-human language communication session with the remote agent; and
dynamically translating between a first human language of a customer operating the SST and a second human language of the remote agent.

12. The method of claim 11, wherein requesting further includes making a request based on an offer for assistance sent from the remote agent to a screen of a display associated with the SST, the request activated from the screen by the customer.

13. The method of claim 11, wherein requesting further includes selecting, by the customer, the first human language from a menu option presented within a screen of a display associated with the SST.

14. The method of claim 13, wherein selecting further includes selecting a mode for the communication session, by the customer, from options presented within the screen.

15. The method of claim 14, wherein selecting the mode further includes presenting the options as one of: an animation with an avatar mode, the animation with the avatar animated to perform sign language mode, a modified video of a person performing sign language mode, an audio only mode, a video and audio mode, a video and text mode, and a written text only mode.

16. The method of claim 11, wherein dynamically translating further includes providing the customer operating the SST with a first communication mode for the communication session that is different than a second communication mode for the communication session received by the remote agent for the communication session.

17. A Self-Service Terminal (SST), comprising:
a language bridge configured and adapted to: i) execute on the SST, ii) establish a communication session with a remote agent, and iii) dynamically bridge between a first human language used by a customer operating the SST and a second human language used by the remote agent during the communication session.

18. The SST of claim 17, wherein the language bridge is further configured and adapted to v) provide the communication session in a communication mode selected by the customer.

19. The SST of claim 18, wherein the communication mode is animated with an avatar representing the customer to the remote agent during the communication session.

20. The SST of claim 17, wherein the SST is an Automated Teller Machine (ATM) and the remote agent is a teller.
